(19) United States
(12) Patent Application Publication
(10) Pub. No.: US 2015/0099020 A1
(43) Pub. Date: Apr. 9, 2015

(54) AQUEOUS DISINFECTANT COMPOSITION

(71) Applicant: NORDICHUG OY, Espoo (FI)

(72) Inventor: Dmitry Genin, Helsinki (FI)

(21) Appl. No.: 14/401,141

(22) PCT Filed: May 14, 2013
(86) PCT No.: PCT/FI2013/050522

§ 371 Date: Nov. 14, 2014

(30) Foreign Application Priority Data
May 14, 2012 (FI) 20125512
Oct. 26, 2012 (FI) 20126117

(51) Int. Cl. A01N 65/34

(52) U.S. Cl. CPC A01N 65/34
USPC 424/765

(57) ABSTRACT

A disinfectant composition is provided comprising an extract comprising phenolic compounds obtainable from Rubus species berries, at least one surfactant and water. This aqueous solution can be used for disinfecting solid surfaces, especially those, which do not tolerate solvents such as high concentration ethanol or isopropanol, preferably touch screens or touch panels. A wiping article comprising said disinfectant composition is provided as well.

### TECHNICAL FIELD

The present invention is related to the field of disinfectant liquid compositions. More specifically said disinfectant composition provides an aqueous antimicrobial composition for use on objects and surfaces poorly tolerant to organic solvents. A wiping article comprising said disinfectant composition is provided as well.

### BACKGROUND

Alcohols, usually ethanol or isopropanol, are sometimes used as a disinfectants, and yet more often as an antiseptics. Alcohols are most effective against microbes when combined with purified water to facilitate diffusion through the cell membrane; 100% alcohol typically denatures only external membrane proteins. A mixture of 70% ethanol or isopropanol diluted in water is effective against a wide spectrum of bacteria on dry objects, though higher concentrations are often needed to disinfect wet surfaces. Additionally, high-concentration mixtures (such as 80% ethanol+5% isopropanol) are required to effectively inactivate lipid-enveloped viruses, such as HIV, hepatitis B, and hepatitis C. Alcohol is, at best, only partly effective against most non-enveloped viruses, such as hepatitis A.

Further shortcoming for use of concentrated alcohol solutions are fire hazards, and storage of flammable reagents requires special arrangements. They also have limited residual activity due to evaporation, which results in short contact times unless the surface is submerged in disinfectant composition. When used as a disinfectant, most typical materials used in laboratory e.g. glass, steel, and porcelain tolerate even high concentrations of alcohol. However, as effective solvents, they may harm others. Some surfaces may be damaged immediately, but most suffer long term deterioration, a kind of ageing, e.g. many plastic materials lose their plasticity and become brittle under repeated exposure to concentrated alcohols. Modern electronic devices are even more delicate.

Another approach for disinfection is use of antimicrobial agents. Biocides have been synthetized or isolated from nature. Natural phenols like phenol and thymol are well-known disinfectants. Thymol is an interesting example of naturally occurring biocides, with strong antimicrobial characteristics when used alone or with other biocides. Studies have demonstrated the antimicrobial effects of thymol ranging from inducing antibiotic susceptibility in drug-resistant pathogens to powerful antioxidant properties. Thymol has also been shown to be an effective fungicide, particularly against fluconazole-resistant strains. Though the exact mechanism is unknown, it has been suggested that thymol produces at least some of its biocidal properties via membrane disruption.

Prior art documents have disclosed some documents employing plant-derived compounds for purification purposes. Utility model DE202004020464 discloses an acidic cleaning composition comprising water, preservatives and vegetable oil and leaf juice, obtained from leaf brew. It implies the composition being useful for removing scale deposits on metal, ceramic, glass, plastics, acid resistant stone or tile surfaces.

U.S. Pat. No. 6,093,401 provides an active coloring concentrate from the juice of cranberries and blueberries by treating juice or homogenate with an appropriate binding matrix. The binding matrices are used to concentrate active materials from cranberry and a colored solid is produced. This substance shows anti-bacterial and anti-viral properties. It can be readily consumed as a therapeutic or nutraceutical, used as a coloring agent, or it can be used topically.

Yet another prior art document U.S. Pat. No. 6,793,941, discloses a contact lens solution reducing the number and wide variety of pathogenic microorganisms that may infect rigid gas permeable or soft contact lenses. Natural occurring compounds alone and in combination with chemical agents used in ophthalmic solutions such as contact lens solution enhance and complement their anti-microbial, cleaning and wetting activity or reduce irritation to the eye. Various buffering and osmotic agents are needed to ensure compatibility with ophthalmic requirements.

Another document in the field of ophthalmic applications, WO9731658A1, suggests compositions containing bioflavonoids. However, both documents in the field of eye care products require several hours' immersing and incubating of the objects to be treated until the anti-microbial effect is obtained. Furthermore, ophthalmic requirements for contact lenses (wetting, buffering, tonicity, counter-irritating, chelating etc.) must be met.

Another document of prior art, WO2009124392, discloses a composition wherein the ingredients are plant extract, surfactant, solvent and water. Said plant extracts are described to comprise phenolic compounds, but because of oiliness are non-compatible with high-tech equipment and furthermore necessarily require a solvent to be present for making said phenolic compounds miscible with water.

Yet another document of prior art, WO2012048119 A2 discloses anti-biofilm compositions and methods for use thereof. They are designed to be compatible with physiology. The application described therein relates to prevention of biofilm formation on surfaces, such as implants, continuously supplied with e.g. nutrients.

The phenolic compounds in berries have been shown to possess antimicrobial activity at least against some types of bacteria. However, berries and derivatives thereof have so far been studied from the point of view of human gastro-intestinal system and nutritional effects. Due to the context, many of the bacterial strains studied have been anaerobic. The compositions published have been optimized taking into account factors that contribute to human health and wellbeing, not to boost disinfectant properties.

Hence, there is a need for novel disinfectant compositions having antimicrobial compounds of plant origin as active components.

### SUMMARY

The present inventors have found that phenolic compounds found in berries combined with surfactant can be used as active components in aqueous disinfection products. Said phenolic compounds obtainable from berries are at least partly soluble in water and can be applied as aqueous solutions having low concentration of or are free from aliphatic C₁-C₄ alcohols. This provides benefits over prior art disinfectants. Aqueous solutions having low concentration of or are free from aliphatic C₁-C₄ alcohols contribute to ecological and environmental safety. Aqueous compositions comprising phenolic compounds found in berries that contain low concentration of or are free from aliphatic C₁-C₄ alcohols have surprisingly provided satisfactory disinfectant properties at the same time being safe to use on delicate surfaces, such as touch screens and panels, and causing no damage to said surfaces.

Herein is provided an aqueous disinfectant composition comprising at least one surfactant and an extract comprising phenolic compounds obtainable from Rubus species berries. By weight said composition comprises preferably

an extract comprising phenolic compounds obtainable from Rubus species berries in a concentration of 0.01-10.0% by weight,
surfactant in a concentration of 0.01-4.0% by weight,
water in an amount sufficient to make the total composition 100% by weight.

Optionally a further additive or further additives may be included in said disinfectant composition in concentration of 0.01-4.0%. Said additive or additives may be selected from second or further surfactants, degreasers, aliphatic C₁-C₄ alcohols, fragrants, colorants or chelating agents.

As an embodiment, the disinfectant composition can be applied by the means of a wiping article comprising a disinfectant composition defined in present claims. Preferably said wiping article comprises a flexible substrate at least partly sprayed, moistened, impregnated and/or wetted with said disinfectant composition.

The invention further provides use of the disinfectant composition or wiping article comprising said disinfectant composition for disinfecting surfaces, preferably solid surfaces of polymeric materials, most preferably touch screens or touch panels.

### DETAILED DESCRIPTION OF THE INVENTION

An object of this invention is to minimize or even eliminate the problems and disadvantages existing in the prior art.

An object of this invention is to minimize or even eliminate the need of organic solvents in high concentrations, like ethanol 70%, in disinfectant compositions.

Another object of the present invention is to provide an alcohol-free aqueous disinfectant composition comprising an extract comprising a surfactant and phenolic compounds found in berries and which is suitable for use as an antimicrobial agent.

Another object of the present invention is to provide an aqueous disinfectant composition comprising an extract rich in phenolic compounds found in berries and which together with a surfactant is suitable for use as an antimicrobial agent.

Another object of the present invention is to provide an aqueous disinfectant composition comprising a surfactant and an extract comprising phenolic compounds found in berries and suitable for use as an antimicrobial agent for disinfection of surfaces consisting substantially of synthetic polymeric materials.

Another object of the present invention is to provide an aqueous disinfectant composition for use on electrical devices and appliances in general, especially those comprising touch screen or touch panel or accessories, such as protective films and/or cases thereto.

Still another object of the present invention is to provide a composition comprising an extract which is rich in phenolic compounds found in berries which is ecologically safe.

Yet another object is to provide a composition comprising an extract comprising phenolic compounds found in berries, which is suitable for treating surfaces which cannot tolerate ethyl alcohol or which deteriorate with repeated exposure to ethyl alcohol.

Yet another object is to provide an aqueous composition comprising an extract comprising phenolic compounds found in berries for use as a disinfectant.

Another object of the present invention is to provide a composition comprising an extract comprising phenolic compounds found in berries which is suitable for use as an antimicrobial agent for disinfection of surfaces. Generally the subjects may be selected from any subjects or surfaces susceptible to microbial contamination, especially due to exposure to human contact, especially skin contact. Most interesting examples of such subjects are touch screens of modern smartphones, tablet computers and touch screens in connection or in relation to medical equipment.

In order to achieve the above-mentioned objects the present invention is characterized in what is defined in the characterizing parts of the independent claims presented hereafter.

If not otherwise stated, all percentages in this application refer to weight percentages of the total, ready to use, aqueous composition.

In the context of the present application, terms “disinfectant”, “disinfectant composition” or “disinfecting composition” refer to substances that are applied to non-living objects to destroy microorganisms that are flocked or adhered on said objects. Disinfection does not necessarily kill all microorganisms, especially resistant bacterial spores. Disinfection is less effective than sterilization, which is an extreme physical and/or chemical process that kills all types of life. Disinfectants are different from other antimicrobial agents such as antibiotics, which destroy microorganisms within the body, and antiseptics, which destroy microorganisms on living tissue. Disinfectants are also different from biocides—the latter are intended to destroy all forms of life, not just microorganisms. Usually, disinfectants work by destroying the cell wall of microbes or interfering with the metabolism.

Sanitizers are substances that simultaneously clean and disinfect.

According to the present invention, the berries are selected from Rubus species. The phenolic compounds extracted from Rubus species have shown excellent antimicrobial properties. Preferable Rubus species are Rubus chamaemorus, Rubus arcticus, Rubus caesius, Rubus saxatilis, Rubus fructiosus, Rubus allegheniensis, Rubus idaeus. Especially attractive results have been shown with raspberry, Rubus idaeus and cloudberry, Rubus chamaemorus. Rubus idaeus is low cost berry easy to cultivate in comparison to Rubus chamaemorus and thus provides more cost efficient source for extracts. However, extracts from Rubus chamaemorus have shown better antimicrobial activity towards bacteria Staphylococcus aureus, and hence can be applied in smaller concentration for equal effect.

Another essential component of the disinfectant composition of the present invention is surfactant. Surfactants are compounds that lower the surface tension of a liquid, the interfacial tension between two liquids, or that between a liquid and a solid. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant molecule contains both a water insoluble moiety and a water soluble moiety. Surfactant molecules will diffuse in water and adsorb at interfaces between air and water or at the interface between oil and water, in the case where water is mixed with oil. The insoluble hydrophobic group may extend out of the bulk water phase, into the air or into the oil phase, while the water soluble head group remains in the water phase. This alignment of surfactant molecules at the surface modifies the surface properties of water at the water/air or water/oil interface.

In the disinfectant composition of the present invention, the surfactant may contribute in enhancing the contact between microbes and active components of the composition. It may further contribute to the solubility of feebly water-soluble phenolic compounds obtainable by extraction from berries. This is extremely important in applications, where solid particles present in the disinfectant composition may scratch or scrape the surface to be disinfected. Especially in environments, where disinfection must be repeated frequently, such as hospitals and laboratories, this characteristic is of high value.

For the purposes of the present invention a surfactant may be selected from anionic surfactants, cationic surfactants, amphoteric surfactants, as well as nonionic surfactants. For an embodiment the disinfectant composition of the present invention the anionic surfactants are preferred being common and widely used. Anionic surfactants, of which sodium laurel sulfate- and sodium dioctyl sulfosuccinate are well-known and approved examples for many purposes. Anionic surfactants when mixed with the berry extract, water and optional further components, may contribute in forming a stable macroemulsion or microemulsion of the disinfectant composition.

In another embodiment, said surfactant is selected from cationic surfactants. One preferable example of a cationic surfactant is benzalkonium chloride, also known as N-Alkyl-N-benzyl-N,N-dimethylammonium chloride; Alkyldimethylbenzylammonium chloride or ADBAC. For dissolution reasons, the amount of benzalkonium chloride in the disinfectant composition of the present invention is advantageously very low, preferably below 1.0%, more preferably less than 0.5% and most preferably less than 0.1% by weight. Good results have been obtained even with the amount of benzalkonium chloride in the disinfectant composition being less than 0.01%.

In other words, the surfactants act to help to solubilize and disperse the phenolic compounds obtainable from berries in the water, making the phenolic compounds obtainable from berries more readily available for antimicrobial activities, ultimately enhancing the disinfecting efficacies thereof and allowing for the use of smaller concentration of the phenolic compounds overall. Furthermore, in comparison to existing cleaner disinfectants typically containing about 3 to 7% of surfactant, the disinfectant compositions of the present invention form a stable solution with the use of less than 3% of surfactant. Synergism between the extract according to the present invention and the surfactant enable the disinfecting effect to be provided with lower concentrations of both extract and surfactant. Again, this further minimizes the production costs and impact on the environment.

At the same time, the use of a low amount of surfactant leads to improved dry-out and wipe profiles. The present inventors also have unexpectedly found that the surfactant, sodium laurel sulfate, of the present invention when combined with the phenolic compounds obtainable from berries and water do not compromise its cleaning efficacy but rather maintain its superior cleaning property as well as being an effective stabilizer. The surfactants of the present invention are therefore enhanced dynamic surfactants which can rapidly reduce the surface tension of the water by making it “wetter” so it can spread and wet the inanimate and animate surfaces in the cleaning process and deliver the phenolic compounds obtainable from berries to the microorganisms faster and more completely.

In an embodiment of the invention, the disinfectant composition further comprises a second surfactant. In a more particular embodiment of the invention, the disinfectant composition comprises about 1% to about 4% of sodium dioctyl sulfosuccinate, suitably about 1.5% to about 2.5% of sodium dioctyl sulfosuccinate. The combination of the sodium dioctyl sulfosuccinate and sodium laurel sulfate is particularly effective in keeping the tough grease and oily films in suspension, while at the same time, not compromising the disinfecting efficacy of the composition. Due to the short relaxation time of the miscelles for providing rapid mobility and exposure of the phenolic compounds to the microorganisms, the disinfecting efficacy of the composition is maintained. Further, the advantage of using such surfactants over other types of surfactants is to maintain the benign environmental and human health and safety profiles of the disinfectant composition.

A degreaser may also be included in the disinfectant composition of the present invention for penetrating and emulsifying grease, oil films and oil-based stains. The degreaser may aid to breakdown heavier soil particles and keep them in suspension, while assuring that the cleaned surfaces remain clean. In an embodiment of the present invention, the degreaser is present in an amount of about 0.01% to about 2% by weight, suitably about 0.3% to about 0.8% by weight. The degreaser may be selected from D-limonene, pine oil and lemon oil. In an embodiment of the invention, the degreaser is D-limonene which is a natural solvent extracted from citrus fruit or seeds thereof. Thus, it is not only biodegradable and non-toxic, but it also dissolves grease and oil very effectively. Optionally, the composition may further comprise thymol in a concentration of 0.01-5.0% by weight enhancing the antimicrobial effect.

In an embodiment of the present invention, the disinfectant composition further comprises about 1% to about 4% by weight of sodium laurel sulfate and about 0.1% to about 1.5% by weight of a degreaser. This combination has been found to be particularly effective as a heavy duty cleaner.

According to a preferred embodiment, the disinfectant composition comprises as an alcohol-free composition

a. an extract comprising phenolic compounds obtainable from Rubus species berries,
b. at least one surfactant,
c. water.

It is understood that ingredients are then selected so that no alcohols, especially aliphatic C₁-C₄ alcohols are involved in the composition. Very promising results have been obtained experimentally. The composition being alcohol-free provides benefits in applications where safety or other requirements prohibit any use of e.g. ethyl alcohol. It has also been found, that prolonged and/or repeated use of aliphatic alcohols damages plastic properties of polymeric materials.

In another embodiment, however, the combination of phenolic compounds obtainable from berries and surfactant may be supplied with a low concentration of an aliphatic alcohol. According to yet another embodiment of the invention, the disinfectant composition further comprises from about 1% to about 5% by weight of total aqueous disinfectant composition of aliphatic C₁-C₄ alcohol. Aliphatic alcohol acts as a solvent or co-solvent to phenolic compounds obtainable from berries. In disinfectant compositions intended for use in delicate surfaces, such as touch screens or panels, it is extremely important that the components of the disinfectant composition are dissolved. Any solid particles could cause scratching and damage to the surface. When concentration of aliphatic C₁-C₄ alcohol does not exceed 5 weight-%, its effect towards the surface to be disinfected is not very detrimental in a sense of removing plasticizers or making the surface brittle. Preferred aliphatic C₁-C₄ alcohols are isopropanol and ethanol. Ethanol is particularly attractive, as it is readily available as natural product increasing the environmentally friendly nature of the disinfectant composition. On the other hand, isopropanol is preferred when the composition should be extremely delicate towards surfaces where it is applied.

For the compositions of some embodiments of the present invention it is not mandatory to be wiped off or rinsed off after being applied to the surfaces. This allows for longer contact with the surface area bearing the microorganisms, and as such ensures a higher killing rate and continuous microbial control for extended period of time where desired. Further, since the disinfectant compositions of the present invention do not necessarily require wiping or rinsing to remove any residues, the disinfectant compositions of the present invention are also convenient and easy to use. In addition, some embodiments of the present invention provide non-corrosive, non-flammable, non-reactive, readily biodegradable disinfectant compositions, which have a low volatile organic compound level.

The disinfectant compositions of the present invention may be formulated by conventional procedures known to one skilled in the art. For example, the disinfectant compositions can be formulated by combining the phenolic compounds obtainable from berries, a surfactant or surfactants, optionally degreaser and/or alcohol, and water together. The combined ingredients are then agitated or mixed until an aqueous solution of phenolic compounds obtainable from berries is formed. Optionally routine measures to enhance the solvation may be used in formulation.

The compositions according to the present invention may include both diluted and concentrated forms which differ only in the relative proportion of water to that of other components forming the compositions. A man skilled in the art understands that a concentrate or stock solution of the disinfectant composition of the present invention can be useful in certain circumstances. Therefore, concentrate for disinfectant composition according to the present invention can be defined comprising a) an extract comprising phenolic compounds obtainable from Rubus species berries, b) at least one surfactant selected from anionic, cationic, amphoteric, and nonionic surfactants, and c) water, wherein the ratio of a to b (a:b) is from 1:150 to 1:2. While the concentrated form of the disinfectant compositions of the present invention may be used as such for heavy cleaning applications, a prescribed dilution, e.g. by ten-fold, is generally required for disinfection. Such may be easily prepared by diluting measured amounts of the concentrated compositions in water by the consumer or other end user in certain volume ratios of concentrate:water, and optionally agitating the same to ensure even mixing of the concentrate in the water. The compositions may be used at various dilutions for cleaning as well. The actual dilution selected is in part determinable by the degree and amount of dirt and grime to be removed from the surfaces, the amount of scrubbing imparted to remove the same, as well as the observed efficacy of the particular dilution. Generally, better results and faster removal is to be expected at lower relative dilutions of the concentrate in water.

As an extreme embodiment, the concentrate for disinfectant composition according to the present invention can be considered as dry formula, comprising a) an extract comprising phenolic compounds obtainable from Rubus species berries, b) at least one surfactant selected from anionic, cationic, amphoteric, and nonionic surfactants, wherein the ratio of a to b (a:b) is from 1:150 to 1:2, to which concentrate water is applied prior to use. Such dry formula is applicable to e.g. wiping articles, which can be moistened or impregnated with water immediately before use for disinfecting surfaces.

Water is included as a carrier in an amount sufficient to make the total composition 100% by weight. The water may be tap water, but is preferably distilled and/or deionized water. If the water is tap water, it is preferably appropriately filtered in order to remove any undesirable impurities such as organics or inorganics, especially mineral salts which are present in hard water and which may thus interfere with the operation of the other components of the composition. Filtering or distillation further contributes to the removal of solid particles helping to avoid scratching of the surfaces to be disinfected. Water is added in amounts which are sufficient to form the diluted composition which amount is prescribed to ensure the antimicrobial efficacy is achieved. Preferably the components of disinfectant composition are soluble in water forming a true solution. Alternatively, the components may be soluble to the mixture of water and surfactant, whereby a solid-free solution is provided. Yet in another embodiment, the components of the disinfectant solution according to the present invention are soluble in mixture of water, surfactant and aliphatic C₁-C₄ alcohol, whereby a solid-free solution is provided.

It is advantageous that the extract is at least substantially solubilized in the aqueous solvent. Preferably the extract is completely solubilized in the aqueous solvent. With “aqueous solvent” is here referred to water together with the surfactant, or optionally water with surfactant and additional component(s). Completely solubilized form enables the use of the disinfectant composition as a spray as well.

Phenolic Compounds Obtainable from Berries

Within the context of the present application “phenolic compounds obtainable from berries” or “phenolic compounds found in berries” refer to group of chemical compounds comprising phenol group and naturally occurring in berries, especially in Rubus species. Phenol group refers structurally to a benzene ring, where at least one substituent group is hydroxide. Other substituents may vary and phenolic compounds isolated from plants have been found to be complex, they often are referred to as polyphenols. Phenol as such is a strong neurotoxin and harmful for humans. However, phenolic compounds obtainable from berries are well tolerated by humans due to low concentration in edible parts and concentration of phenolic compounds in berry skin and seeds, which remain practically intact in digestive system.

The range of phenolic compounds in plants is broad and they are contributing in many functions of plants, e.g. providing aroma, colour, protection against UV-radiation, insects, and micro-organisms. For antimicrobial activity, one group of interesting phenolic compounds in Rubus-species is ellagitannins that have been shown to prevent growth of harmful bacteria, namely salmonella, staphylococcus, and campylobacteria. Mechanism of growth prevention is believed to be more beneficial than simply killing bacteria, because the latter leads to development of resistant strains more easily. An extract comprising ellagitannins are thus preferred in the disinfectant composition according to the present invention. Preferably the concentration of ellagitannin in the final disinfectant composition is at least 10 μM, preferably at least 50 μM, more preferably at least 100 μM and most preferably at least 500 μM.

Extraction of Phenolic Compounds from Rubus Species Plant Parts

Extracting active substances from plants or parts thereof is an ancient art. A man skilled in the art comprehends the wide variation for the pretreatment available for the plant material of interest. Extraction may be performed to fresh, dried or by other means conserved plant parts. To promote extraction, plant parts may be cut, crushed, ground, pressed or broken by operations suitable for exposing the plant material or tissue to an extractant.

The phenolic compounds of interest were first found and extracted from berries. However, other plant parts comprising said phenolic compounds are potential sources as well, provided that they are abundantly available and extraction is easily executed. The plant parts are widely understood to comprise leaves, stems, twigs, roots, flowers, buds, fruits, berries, seeds, kernels, bark, pollen, rhizomes, aerial roots etc. Any combinations of plant parts or fractions thereof are usable as well. Most common, however, are leaves, stems, fruits, berries and seeds or fragments thereof which are rich with phenolic compounds. With fragments is here referred to plant part derivatives after processing, e.g. presscakes obtained as side products from juice production.

Modern cell culturing and recombinant techniques provide further options for extract sources. Plant parts or plant cells rich in phenolic compounds of interest may be cloned into efficient producer strains. Routine measures and procedures are known to a man skilled in the art for reproducing selected plant cells for large scale production. Such cell cultures and/or cells isolated therefrom may then be used as starting material for extraction and further processed similarly to e.g. berries.

Phenolic compounds of interest are obtainable from plant parts, such as berries, by extraction. Range of compounds obtainable is referred to here as an extract, more specifically within preferred embodiments as “berry extract”. The solvent is selected in a way to enable an extract rich in phenolic compounds to be recovered. If the extract is recovered as several fractions, a fraction or a number of fractions exhibiting high total phenolic content is selected. The selection may be based e.g. on total phenolic content measurement expressed as gallic acid equivalents (GAE) in milligrams per gram of dry material.

Said extract contains other compounds as well but for the purpose of the present invention, the phenolic compounds are essential. One option for extracting said phenolic compounds from berries is to use common organic solvents either alone or as aqueous solutions, e.g. acetone/water or ethanol/water. Typical ratio of organic solvent to water is 70:30 vol/vol, but ratios may vary from 9.9:0.1 to 0.1:9.9, depending on the raw materials and components of interest.

It is possible to use as solvent water, ethanol, ethanol/water, acetone, butylene glycol, butylenes glycol/water, glycerine or their mixtures in the extraction of the residual material. A mixture of butylene glycol and water, a mixture of glycerine and water or a mixture of ethanol and water may be used as a solvent. Use of these solvents provides the safety and environmental benefits. According to another embodiment, the solvents used for extraction of phenolic compounds need not necessarily to be approved for food production, and solvents such as tetrachloroethylene, toluene or methyl or ethyl acetate may be used.

One example of the protocol for preparation of an extract according to the present invention, is basically described in the publication Puupponen-Pimiä et al., (2001) in section “Preparation and analysis of phenolic berry extracts”. As an example of extraction, berries can be optionally frozen, then lyophilized and homogenized with solvent (acetone:water 70:30 vol/vol) in a centrifuge tube. After centrifugation, clear supernatant is collected and procedure repeated once or several times to harvest phenolic compounds carefully. After evaporation of the solvents, dry residue thus obtainable can be dissolved in water. In some embodiments of this invention, the dissolution is aided with small amount of aliphatic C₁-C₄ alcohol. In some embodiments, solvent residues could even yield better performance, as disinfection composition is totally free from solid particles.

Another option for extraction is to use a two-step extraction procedure, wherein carbon dioxide (CO₂) extraction precedes solvent extraction. CO₂ extraction is a technology for isolating sensitive components from valuable raw materials. Carbon dioxide is used in the form of fluid or supercritical fluid for extracting the components of interest from the natural raw material. Due to the absence of organic solvents and oxygen the extracts are free of solvent residues and oxidative damages.

CO₂ extraction technology is used for manufacturing of essential oils, natural fragrances, specialty oils and lipid extracts. Carbon dioxide extracts from plant materials are widely used as ingredients of food, food supplements, personal care products and medicines, where the requirement for zero residual solvents exists.

Certain bioactive compounds are released from the cellular structure of the berries, and enriched during CO₂ extraction process to the residual material, whereby some of the compounds are enriched and present in the forms of high biological activity and bioavailability in the residual material.

According to one preferred embodiment the extract is obtainable by extracting a residue from a CO₂ extraction process by using a solvent different from CO₂. The extracts obtainable by further extracting the residual material have composition significantly different from those obtainable by extraction of native plant raw material. From the residues obtainable from the CO₂ extraction process the enriched compounds may be recovered simply and fast by a further extraction with another, different solvent. It has been found out that especially the extraction of polar, hydrophilic components such as sugars, sugar alcohols, sugar derivatives, phenolic compounds, proteins, peptides, amino acids, fibres, oligosaccharides or polysaccharides, from the residues is more efficient compared to the extraction from the corresponding native raw material. In addition, many steps of further cleaning may be omitted due to the low content of disturbing substances in the residue used as raw material.

According to one embodiment of the invention the extract is essentially free of disturbing solid particles originating from raw materials. Possible disturbing solid material may be separated from the obtainable extract after the actual extraction with different solvent than CO₂. Disturbing solid material may be removed from the extract by for example filtration and/or centrifugation.

The obtainable extracts are normally in form of liquid extracts. The extract may also be obtainable in particulate powder form after solvent removal. According to one embodiment of the invention the extract is dried and brought into solid, often powder-like, form. The used solvent is first separated from the extract, which is then dried. The drying may be performed by any suitable drying method, for example, by air drying, oven-drying, freeze-drying, vacuum-drying or spray drying.

It is also possible to add further enriching, refining and/or purifying steps before or after the drying of the extract in order to produce extracts of high purity and/or high concentration of selected components. The refining and purifying methods may include, but not be limited to, extraction with different solvents or chromatography in different columns. Suitable solvents are e.g. water, ethanol, or mixtures of acid/water, water/ethanol or acid/water/ethanol. Suitable column for chromatographic refining and purifying is e.g. an adsorption silica column or an ion exchange column.

The total amount of phenolic compounds, such as flavonoids, phenolic acids and tannins in extracts may be in the range of 0.1 weight-% to 99.9 weight-%, typically from 0.5-70 weight-%, preferably 0.5-50 weight-%, more preferably 1-10 weight-%, still more preferably 1-5 weight-%. The phenolic compounds in the extract provide effective disinfection properties.

Procedures to increase the yield in the extraction are known as well. Patent application WO 2011/015706 is related to enzymatic treatment of the berry raw material. That technology can be used before extraction to increase the content of phenolic compounds in the berry raw material. Hence, within the scope of the present invention, the berry material can optionally be pre-treated with enzymes according the method of WO 2011/015706 before extraction.

### Wiping Article

According to another embodiment of the present invention, herein is provided a wiping article comprising a flexible substrate and disinfectant composition according to embodiments of the present invention. Said flexible substrate can be treated with the disinfectant composition described above wherein the treatment is selected from moistening, wetting and impregnating said substrate. According to a preferable embodiment, said wiping article is partly dry and partly moist with disinfectant composition providing means for both disinfecting and drying a surface. This may be implemented e.g. by spraying said disinfectant composition to the center of a sheet-like wiping article and leaving edges dry. At least said wiping article comprises said wiping article and aqueous disinfectant composition comprising an extract from Rubus species, a surfactant and water. The flexible substrate may be such that is described in publication EP0604996 A2 page 2, line 56 to page 3 line 34.

### Touch Screens, Touch Panels and the Like

By definition, touch screens and touch panels are touched, typically with human skin. Touch screens can be also controlled by any means such as tools and computer accessories eyes or stylus, which is a pen-form device compatible with most capacitive touch surfaces. However, the type of use makes these screens and panels prone to smudging and microbial contamination.

Typically these surfaces are manufactured from polymeric materials or reinforced glass. Furthermore, the touch screen or panel may be protected by disposable cover typically consisting mainly of polyurethane material. Panels could optionally be protected by oleophobic coating, which is sensitive to solvents as well. The technologies have been optimized for touch by human skin, especially human thumb and fingers or alternatively other parts of hand. This exposes said screens and panels to contamination, both chemical and microbiological. In environments, where the risk for infection is high, such as schools, kinder-gardens, daycare centers, airports, and where there further must be maintained a high standard of hygiene, such as hospitals, clinics, there is a demand for non-toxic and yet effective disinfectant composition which does not damage the touch screen materials or shields or covers thereon.

Even though the outer surface of the touch screen or panel may be made of glass durable against organic solvents such as ethanol, there still can be parts, such as frames or other settings surrounding the panel, which are made of materials poorly tolerable. Therefore, the disinfectant composition according to the present invention provides benefits over prior art solutions in use for disinfecting electrical devices and appliances in general, especially those comprising touch screen or touch panel or any accessories thereto.

The findings with disinfection of touch screens are applicable to normal LCD, IPS and LED panels of TVs, computer monitors, control devices thereof or medical devices intolerable to long term resistance against organic solvents. Disinfection of various medical devices that are made of rubber, polymers or other materials which are not resistant in long term to alcohol, such as wires and other flexible polymer or rubber devices and components.

Other applications can be found in home and office use—various electronic and mechanical devices, coated surfaces like painted or covered furniture, sports equipment, toys, child-care devices etc.

### EXAMPLES

The present inventors have developed novel disinfectant compositions for disinfection of modern equipment. The efficiency of the disinfectant compositions was confirmed by in vitro-studies against pathogenic bacteria, which commonly inhabits the human skin. The formulas were tested as ready to use solutions and were analysed for bactericidal potential by MPN (most probable number)-method.

Proof of concept is produced by following examples showing the effective concentration, applicability different surfaces and the speed and duration of the disinfection. The growth and sensitivity of microbes under non-optimized growth conditions when exposed to disinfectant composition of the present invention is studied as well.

### Experimental

The berry extract used in examples 1-5 was obtained by extraction from berries of Rubus chamaemorus. The extraction was performed according to method described in the publication Puupponen-Pimiä et al.

Following disinfectant compositions (formulas, see Table 1) were tested for their efficiency against pathogenic bacteria Staphylococcus aureus DSM20231 and/or Escherichia coli DSM 1103. An overnight culture of S. aureus or E. coli was diluted in saline (0.9% NaCl) to a cell density of 1*10⁷-1*10⁸ cfu/ml. Cell density was confirmed first by a spectrophotometer (OD 600 nm to be near ˜0.07) and additionally counting by Thomas counting chamber under microscope. This bacterial stock solution was diluted tenfold in each biocide/disinfectant solution or saline and incubated for 10 minutes or 3 hours prior to quantification of viable bacteria. All dilutions were analysed in three replicates.

Most probable number method was used to assess the viability of S. aureus in cleaning and disinfectant compositions. Negative control was bacteria incubated in 0.9% NaCl solution. The number of live cells was studied by culturing a dilution series in the Tryptic soy broth growth medium. Absorbance (OD 600 nm) was measured with a 96-well plate reader before and after the 24-hour incubation at +37° C.

Thomas formula was used to estimate the number of viable cells:

MPN/g=(Σgⱼ)/(ΣtⱼmⱼΣ(tⱼ−gⱼ)mⱼ)^{(1/2)}

where the summation is over the selected dilutions and
Σgⱼ denotes the number of positive tubes in the selected dilutions,
Σtⱼmⱼ denotes the grams of sample in all tubes in the selected dilutions,
Σ(tⱼ−gⱼ)mⱼ denotes the grams of sample in all negative tubes in the selected dilutions.

### Example 1

Example 1 was conducted to monitor the physical properties and stability of different variations of the disinfectant compositions according to the present invention.

Cleaning and disinfectant compositions (formula) were made for microbial treatments as listed in Table 1. These compositions differ in the amount of the berry extracts as well as in the nature of the additives and their concentrations.

TABLE 1
Cleaning and Disinfectant Compositions (given as weight -%).

| Components | NH-01 | NH-02 | NH-03 | NH-11 | NH-12 | NH-13 | NH-21 | NH-22 | NH-23 |
|---|---|---|---|---|---|---|---|---|---|
| Berry extract | 0.05 | 0.10 | 0.50 | 0.05 | 0.05 | 0.05 | 0.05 | 0.05 | 0.05 |
| Sodium Laurel Suphate | 2.50 | 2.50 | 2.50 | 2.5 | 2.50 | 0.25 | 0.25 | 2.50 | 0.25 |
| Sodium Dioctyl Sulfoccinate | | | | 1.50 | | | 0.05 | | |
| Sodium Alkyl Ether Sulfate | | | | | | 0.05 | 0.05 | | |
| Glocopon | | | | | | 0.05 | 0.05 | | |
| Ethyl alcohol | | | | | 1.50 | 1.50 | 1.50 | | |
| Trilon | | | | | | | | 0.03 | 0.03 |
| Water | to | to | to | to | to | to | to | to | to |
| | 100% | 100% | 100% | 100% | 100% | 100% | 100% | 100% | 100% |

### Example 2

Example 2 was conducted to study the effect of the concentration of the berry extract as well as the effect of incubation time on the disinfection efficiency.

S. aureus cell numbers (cfu-values) after 10 min and 3 h incubations with formulas NH-03 and NH-22 were measured. Control sample was S. aureus incubated in saline (0.9% NaCl).

Before MPN-analysis the absorbance of Staphylococcus aureus solution (OD 600 nm) was 0.0859 in saline (0.9% NaCl) and the cell density according to Thomas counting chamber 6.7×10⁷ cfu/ml. The stock solutions were diluted 10-fold to saline or to NH-03/NH-22 formulas.

Live cells of Staphylococcus aureus in saline after 10 min and 3 h incubation at room temperature were 6.7×10⁵ cfu/ml and 3.5×10⁵ cfu/ml respectively. No live cells of the Staphylococcus aureus were detected after 10 min or 3 h incubation in NH-03 or NH-22 formulas. NH-03 and NH-22 formulas inhibited the S. aureus growth completely in both 10 min and 3 h incubations.

### Example 3

Example 3 was conducted to study the disinfection efficiency with short exposure to the disinfection composition varying the concentrations of the formula components.

S. aureus cell numbers (cfu-values) after 10 min incubation with formulas as listed in Table 2 were measured. Control was S. aureus incubated in saline (0.9% NaCl).

Before MPN-analysis the absorbance of Staphylococcus aureus solution (OD 600 nm) was 0.0938 in saline (0.9% NaCl) and the cell density according to Thomas counting chamber 1.0×10⁸ cfu/ml. The stock solutions were diluted 10-fold to saline or to 9 formulas for which the results are listed in table 2. Live cells of Staphylococcus aureus in saline after 10 min incubation at room temperature were 6.58×10⁵ cfu/ml. This value was used to calculate the inhibition-%. No live cells of the Staphylococcus aureus were detected after 10 min incubation in formulas as listed in Table 2. All formulas were efficient in killing gram-positive S. aureus.

TABLE 2
S. aureus inhibition as cell numbers and inhibition-percentages.

| Treatment # | Formula | Inhibition-% |
|---|---|---|
| 1 | NH-03 | 100.00 |
| 2 | NH-01 | 100.00 |
| 3 | NH-02 | 100.00 |
| 4 | NH-22 | 100.00 |
| 5 | NH-12 | 100.00 |
| 6 | NH-11 | 100.00 |
| 7 | NH-23 | 100.00 |
| 8 | NH-21 | 100.00 |
| 9 | NH-13 | 100.00 |

### Example 4

Example 4 was conducted to study the disinfection effect of the on different bacterial varieties.

E. coli cell numbers (cfu-values) after 10 min and 3 h incubations with formula NH-03 were measured. Control was E. coli incubated in saline (0.9% NaCl).

Before MPN-analysis the absorbance of E. coli solution (OD 600 nm) was 0.1054 in saline (0.9% NaCl) and the cell density according to Thomas counting chamber 6.0×10⁷ cfu/ml. The stock solutions were diluted 10-fold to saline or to NH-03 formulas.

Live cells of E. coli in saline after 10 min and 3 h incubation at room temperature were 3.01×10⁷ cfu/ml and 1.79×10⁷ cfu/ml respectively. Live cells of E. coli in NH-03 after 10 min and 3 h incubations at room temperature were 3.67×10² cfu/ml and 2.04×10² cfu/ml respectively. NH-03 formula inhibited the E. coli growth by 99.9% in 10 min and 3 h incubations.

### Example 5

Example 5 was conducted to study the disinfection efficiency with short exposure of E. coli cells to the disinfection composition.

E. coli cell numbers (cfu-values) after 10 min incubation with formulas as listed in Table 3 were measured. Control was E. coli incubated in saline (0.9% NaCl).

Live cells of E. coli in saline and in the formula were measured after 10 min incubation at room temperature and bacteria growth were inhibited in the first 10-fold dilution in MPN analysis at least by 89%.

TABLE 3
E. coli inhibition-% as cell numbers and inhibition-percentages.

| Treatment # | Formula | Inhibition-% * |
|---|---|---|
| 1 | NH-03 | 99.99 |
| 2 | NH-01 | 91.24 |
| 3 | NH-02 | 91.06 |
| 4 | NH-22 | 93.36 |
| 5 | NH-12 | 89.38 |
| 6 | NH-11 | 93.51 |
| 7 | NH-21 | 94.98 |

* Inhibition in the first 10-fold dilution in MPN analysis

### Example 6

Another composition according to present invention, R 92 formula, was prepared. It comprised an extract comprising phenolic compounds from Rubus-species berries, Sodium laurel suphate as surfactant, a cationic surfactant, benzalkonium chloride, as a further surfactant and additionally water.

R 92 formula was delivered to an analysis provider as ready to use concentration (1%). Formula was analyzed against Escherichia coli strain DSM 1103 and Staphylococcus aureus strain DSM 20231. An overnight culture of each bacterial strain were diluted in saline (0.9% NaCl) to a cell density of 1×10⁷-1×10⁸ cfu/ml. Cell density was confirmed by a spectrophotometer (OD 600 nm) and it was 0.0750 for S. aureus and 0.1337 for E. coli. These bacterial stock solutions were diluted tenfold in disinfectant composition and incubated for 60 minutes prior to quantification of viable bacteria. Negative control was bacteria incubated in saline (0.9% NaCl). All treatments were analyzed in three replicates. The number of live cells was studied by culturing a dilution series in the Tryptic soy broth (TSB) growth medium. Absorbance (OD 600 nm) was measured by 96-well plate reader immediately before and after the 24-hour incubation at +37° C.

Thomas formula was used to estimate the number of viable cells as described earlier.

### Results

R 92 formula was bacteriosidic against E. coli inhibiting cell growth completely (Table 4) and bacteriostatic against S. aureus inhibiting the growth in the presence of 9% of the formula. S. aureus cell number was 4.7×104 cfu/ml in the presence of R 92 solution and 9.5×10⁵ cfu/ml in the absence of it (CTRL, Table 5).

TABLE 4
E. coli cell numbers.

| | | Incubation | |
|---|---|---|---|
| Treatment # | Formula | time | cfu/ml |
| 1 | R 92* | 60 min | nd |
| 2 | CTRL (saline) | 60 min | 2.3 × 10⁷ |

nd = no growth detected

TABLE 5
S. aureus cell numbers.

| | | Incubation | |
|---|---|---|---|
| Treatment # | Formula | time | cfu/ml |
| 1 | R 92* | 60 min | 4.7 × 10⁴ |
| 2 | CTRL (saline) | 60 min | 9.5 × 10⁵ |

*Inhibition in the first 10-fold dilution in MPN analysis (in the presence of 9% of the original biocide)

### CONCLUSIONS

The examples conducted showed that the components of disinfectant composition form solutions in water. This is important, especially considering the embodiments where the surfaces to be disinfected are delicate and prone to scratching. Furthermore, example compositions were stable and suitable for storage at room temperature.

Further, the examples confirmed that the berry extract content as low as 0.05 w-% together with surfactant was sufficient for eliminating 100% of live S. aureus cells and at least 90% of E. coli in alcohol free compositions. The incubation time of 3 hours was sufficient for eliminating live bacterial cells in formulas tested. It was an unexpected finding that the differences between 10 minutes incubation and 3 hours incubation were negligible. Actually, the incubation time of 10 minutes was surprisingly efficient for disinfecting the samples, thereby enabling the use in applications, where lengthy immersion within disinfectant composition is not feasible or even possible. The response of S. aureus live cells in 10 minutes was immediate and complete, whereas the result with E. coli showed more variation, yet reaching an excellent live-cell elimination of about 90%.

The contribution to the disinfectant composition of chelating agent, Aminopolycarboxylate (Trilon from BASF), was shown especially in the example 5, where the inhibition efficiency for formula NH-22 overrules that of NH-01. Similarly, the synergistic effect of two surfactants was clearly shown with experiments conducted with formulas NH-11 and R 92.

### REFERENCE

Puupponen-Pimiä et al., Journal of Applied Microbiology 2001, 90, 494-507.S

1. An alcohol-free disinfectant composition comprising
an extract comprising phenolic compounds obtainable from Rubus species berries,
at least one surfactant; and
water;
wherein the alcohol-free disinfectant composition is free from aliphatic C₁-C₄ alcohol.

2. The alcohol-free disinfectant composition according to claim 1 comprising
0.01-10.0% by weight of said extract,
0.01-4.0% by weight of said at least one surfactant,
optionally 0.01-4.0% by weight of additional components, and
water in an amount sufficient to make the total composition 100% by weight.

3. (canceled)

4. The alcohol-free disinfectant composition according to claim 2, wherein the additional components are selected from a second or a further surfactant, degreaser, fragrant, colorant or chelating agent.

5. The alcohol-free disinfectant composition according to claim 2, wherein the additional components are selected from a second or a further surfactant, degreaser, fragrant, colorant or chelating agent.

6. The alcohol-free disinfectant composition according to claim 1 wherein the extract is substantially solubilized in an aqueous solvent.

7. The alcohol-free disinfectant composition according to claim 1 wherein the at the least one surfactant is selected from cationic, anionic, amphoteric, and nonionic surfactants, preferably the at least one surfactant is an anionic surfactant.

8. The alcohol-free disinfectant composition according to claim 1, wherein the Rubus species is selected from Rubus idaeus and Rubus chamaemorus.

9. (canceled)

10. A concentrate of the alcohol-free disinfectant composition according to claim 1, wherein the ratio of a. to b. is from 1:150 to 1:2.

11. A wiping article comprising a flexible substrate and the alcohol-free disinfectant composition according to claim 1.

12. A method of disinfecting surfaces, preferably solid surfaces of polymeric materials, most preferably touch screens or touch panels, the method comprising applying the disinfectant composition of claim 1 on the surface.

13. A method of disinfecting and cleaning surfaces, preferably solid surfaces of polymeric materials, most preferably touch screens or touch panels, the method comprising applying the concentrate according to the claim 10 on the surface, optionally followed by removing residual concentrate.

14. A wiping article comprising a flexible substrate and the concentrate according to claim 10.

15. A method of disinfecting surfaces, preferably solid surfaces of polymeric materials, most preferably touch screens or touch panels, the method comprising wiping the surface with the wiping article according to claim 11.
